(19) United States
(12) Patent Application Publication
(10) Pub. No.: US 2009/0112691 A1
(43) Pub. Date: Apr. 30, 2009

(54) System and method for scheduling online keyword auctions over multiple time periods subject to budget and query volume constraints

(75) Inventors: Zoe Abrams, Kensington, CA (US); Ofer Mendelevitch, Redwood City, CA (US); Sathiya Keerthi Selvaraj, Cupertino, CA (US); John Anthony Tomlin, Sunnyvale, CA (US)

Correspondence Address: Law Office of Robert O. Bolan, P.O. Box 36, Bellevue, WA, 98009, US

(73) Assignee: Yahoo! Inc., Sunnyvale, CA (US)

(21) Appl. No.: 11/981,319

(22) Filed: Oct. 30, 2007

(51) Int. Cl. G06Q 30/00; G06F 17/30; G06Q 10/00

(52) U.S. Cl. 705/10; 707/3; 705/14; 705/7; 705/37; 707/E17.014

(57) ABSTRACT

An improved system and method for scheduling online keyword auctions over multiple time periods subject to budget constraints is provided. A linear programming model of slates of advertisements may be created for predicting the volume and order in which queries may appear throughout multiple time periods for use in allocating bidders to auctions to optimize revenue of an auctioneer. Each slate of advertisements may represent a candidate set of advertisements in order of optimal revenue to an auctioneer. Linear programming using column generation with the keyword as a constraint and a bidder's budget as a constraint may be applied for each time period to generate a column that may be added to a linear programming model of slates of advertisements. Upon receiving a query request, a slate of advertisements for the time period may be output for sending to a web browser for display.

### FIELD OF THE INVENTION

The invention relates generally to computer systems, and more particularly to an improved system and method for scheduling online keyword auctions over multiple time periods subject to budget and query volume constraints.

### BACKGROUND OF THE INVENTION

Most theoretical analysis of online keyword auction mechanisms has neglected the practical aspect of limited budgets for the buyers. Several publications describe on-line algorithms for conducting sponsored search auctions, sometimes with budget constraints. However, these approaches apply approximation algorithms that unfortunately are unable to predict or efficiently use forecast query data. As a result, various implementations of online keyword auctions may only ensure that daily budget limits for buyers are not exceeded at the expense of negatively impacting the auctioneer's objective.

For instance, an implementation may use a throttling rate for budgeting. In this case, a buyer may only be permitted to participate in a percentage of auctions in which the buyer may actually wish to bid so that the buyer's daily spend may not exceed the buyer's daily budget. If the buyer's daily spend may in fact exceed the daily budget, then the buyer may become completely throttled and no longer participate in bidding for auctions that day. This may result in removing more and more buyers from auctions as the day progresses than may be necessary, considering spend and budget over the course of a day.

A different implementation including the highest bidders may be combined with throttling so that each buyer may continue to participate in each auction as long as a buyer's remaining daily budget may not be exceeded. However, such an implementation may also fail to provide the optimal objective for an auctioneer. At some point in the day, a buyer that may be able to bid on a variety of keyword auctions may actually spend the entire daily budget as the highest bidder on frequently occurring keywords, and thereby be removed as an available buyer for bidding on less frequently occurring keywords. Thus, this greedy approach may also result in removing more buyers from auctions as the day progresses than may be necessary considering pricing and frequency of keywords over the course of a day.

What is needed is a system and method that may optimize the objective for an online auctioneer while ensuring that spending by buyers remains within their specified budget constraints. Such a system and method should be able to take into consideration sequencing of daily queries and budgeting by buyers throughout multiple periods of a time span. Such a system and method should be able to support an auctioneer's objective to maximize revenue and/or to maximize overall “social” value of the auctioned keywords to the bidders.

### SUMMARY OF THE INVENTION

Briefly, the present invention may provide a system and method for scheduling online keyword auctions over multiple time periods subject to budget and query volume constraints. In various embodiments, a client having a web browser may be operably coupled to a query processing server for sending a query request. The query processing server may include a model generator for creating a linear programming model used to provide a candidate set of advertisements for keywords of query requests for multiple time periods. The query processing server may also include an operably coupled linear programming analysis engine for optimizing the linear programming model offline to generate slates of advertisements for keywords of a query request for multiple time periods and to generate a frequency for each slate to indicate how often the slate of advertisements should be displayed. The query processing server may then choose a slate of advertisements online for a time period in accordance with the generated frequencies to provide a slate of advertisements accompanying search results of a query request to the web browser.

In an embodiment, the linear programming analysis engine may associate with each slate of advertisements an indicator of priority or value, and an expected traffic volume. In such an embodiment, the query processing server may choose a slate of advertisements online in accordance with the expected traffic priorities and values prescribed.

The query processing server may also be operably coupled to a database of advertisements that may include any type of advertisements that may be associated with an advertisement ID. In an embodiment, several bidders may be associated with an advertisement ID. The database of advertisements may also include a collection of advertisement slates that may be generated as part of the linear programming model. Each of the advertisement slates may represent an ordered candidate set of advertisements for keywords of a query request.

The present invention may provide a framework for predicting the volume and order in which queries may appear during multiple time periods of a time span for use in allocating bidders to auctions to optimize revenue of an auctioneer. A linear programming model of slates of advertisements for multiple time periods may first be created offline along with frequencies indicating how often each slate of advertisements should be displayed. Each slate of advertisements may represent an ordered candidate set of advertisements, where the ordering may be determined in whole or in part by the bids of the buyers according to the rules set by the auctioneer. To do so, a subset of queries and bidders may be selected; an estimate of the number of queries may be obtained for each of the multiple time periods; an overall budget may be calculated for each bidder for the time span of the multiple time periods; and ranked slates of advertisements may be determined for the subset of queries for each of the multiple time periods. Linear programming using column generation with the forecast keyword occurrences as a constraint and the bidders' budgets as a constraint for each of the multiple time periods may be applied to generate columns that may be added to the linear programming model of slates of advertisements in order to produce the optimal objective to an auctioneer. Upon receiving a query request, a slate of advertisements may be chosen online for the time period according to the previously generated frequencies, and the chosen slate of advertisements that may provide an optimal objective to the auctioneer may then be output for sending to a web browser for display.

In various embodiments, a linear program using column generation may be solved for a time span and may be periodically adjusted as the results of the linear program may be applied to respond to queries with slates of advertisements. Periodically, the remaining budget for bidders and the remaining forecast query volume may be determined and used to resolve the modified linear program using column generation for the remainder of the time span. This may allow slate frequencies to adjust to variations of predicted parameters throughout the course of the time span. In various other embodiments, a linear program using column generation may be solved for a time span to derive the portion of a bidder's budget for spending on each query, and then a linear program may be generated for each query at periodic time intervals to determine slates for use for that particular query, rather than periodically adjusting parameters of the linear program and resolving a modified linear program using column generation at periodic time intervals.

Advantageously, the present invention may effectively use a forecast of the frequency and sequence of keywords occurring for multiple time periods of a time span for optimizing the objective of an auctioneer. By scheduling bidders to auctions, the present invention may also provide improved coverage for multi-keyword bidders. Other advantages will become apparent from the following detailed description when taken in conjunction with the drawings, in which:

### BRIEF DESCRIPTION OF THE DRAWINGS

FIG. 1 is a block diagram generally representing a computer system into which the present invention may be incorporated;

FIG. 2 is a block diagram generally representing an exemplary architecture of system components for scheduling online keyword auctions for multiple time periods over a time span subject to budget and query volume constraints, in accordance with an aspect of the present invention;

FIG. 3 is a flowchart for generally representing the steps undertaken in one embodiment for scheduling online keyword auctions for multiple time periods over a time span subject to budget and query volume constraints by applying linear programming using column generation, in accordance with an aspect of the present invention;

FIG. 4 is a flowchart for generally representing the steps undertaken in one embodiment for applying linear programming using column generation to determine a relative frequency for each slate to provide optimal revenue for each of the multiple time periods over a time span, in accordance with an aspect of the present invention;

FIG. 5 is a flowchart for generally representing the steps undertaken in one embodiment for determining one or more slates of advertisements that may improve the objective by generating one or more columns of the linear programming model for a time period, in accordance with an aspect of the present invention;

FIG. 6 is a flowchart for generally representing the steps undertaken in one embodiment for responding to queries applying the results of a linear programming model of advertising auctions subject to budget constraints, in accordance with an aspect of the present invention;

FIG. 7 is a flowchart for generally representing the steps undertaken in one embodiment for scheduling online advertising auctions subject to budget constraints by periodically adjusting parameters of a linear program using column generation, in accordance with an aspect of the present invention; and

FIG. 8 is a flowchart for generally representing the steps undertaken in one embodiment for scheduling online advertising auctions subject to budget constraints by periodically adjusting parameters of many linear programs using column generation, one for each query, to determine slates for use for each particular query, in accordance with an aspect of the present invention.

### DETAILED DESCRIPTION

### Exemplary Operating Environment

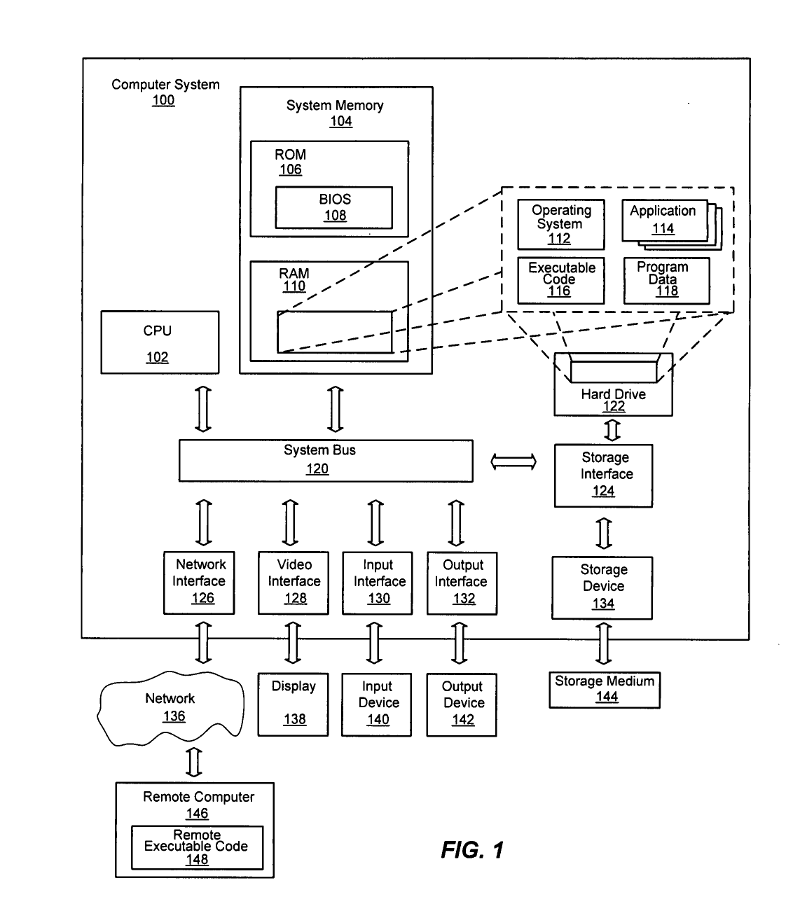

FIG. 1 illustrates suitable components in an exemplary embodiment of a general purpose computing system. The exemplary embodiment is only one example of suitable components and is not intended to suggest any limitation as to the scope of use or functionality of the invention. Neither should the configuration of components be interpreted as having any dependency or requirement relating to any one or combination of components illustrated in the exemplary embodiment of a computer system. The invention may be operational with numerous other general purpose or special purpose computing system environments or configurations.

The invention may be described in the general context of computer-executable instructions, such as program modules, being executed by a computer. Generally, program modules include routines, programs, objects, components, data structures, and so forth, which perform particular tasks or implement particular abstract data types. The invention may also be practiced in distributed computing environments where tasks are performed by remote processing devices that are linked through a communications network. In a distributed computing environment, program modules may be located in local and/or remote computer storage media including memory storage devices.

With reference to FIG. 1, an exemplary system for implementing the invention may include a general purpose computer system 100. Components of the computer system 100 may include, but are not limited to, a CPU or central processing unit 102, a system memory 104, and a system bus 120 that couples various system components including the system memory 104 to the processing unit 102. The system bus 120 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer system 100 may include a variety of computer-readable media. Computer-readable media can be any available media that can be accessed by the computer system 100 and includes both volatile and nonvolatile media. For example, computer-readable media may include volatile and nonvolatile computer storage media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by the computer system 100. Communication media may include computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. For instance, communication media includes wired media such as a wired network or direct-wired connection, and wireless media such as acoustic, RF, infrared and other wireless media.

The system memory 104 includes computer storage media in the form of volatile and/or nonvolatile memory such as read only memory (ROM) 106 and random access memory (RAM) 110. A basic input/output system 108 (BIOS), containing the basic routines that help to transfer information between elements within computer system 100, such as during start-up, is typically stored in ROM 106. Additionally, RAM 110 may contain operating system 112, application programs 114, other executable code 116 and program data 118. RAM 110 typically contains data and/or program modules that are immediately accessible to and/or presently being operated on by CPU 102.

The computer system 100 may also include other removable/non-removable, volatile/nonvolatile computer storage media. By way of example only, FIG. 1 illustrates a hard disk drive 122 that reads from or writes to non-removable, nonvolatile magnetic media, and storage device 134 that may be an optical disk drive or a magnetic disk drive that reads from or writes to a removable, a nonvolatile storage medium 144 such as an optical disk or magnetic disk. Other removable/non-removable, volatile/nonvolatile computer storage media that can be used in the exemplary computer system 100 include, but are not limited to, magnetic tape cassettes, flash memory cards, digital versatile disks, digital video tape, solid state RAM, solid state ROM, and the like. The hard disk drive 122 and the storage device 134 may be typically connected to the system bus 120 through an interface such as storage interface 124.

The drives and their associated computer storage media, discussed above and illustrated in FIG. 1, provide storage of computer-readable instructions, executable code, data structures, program modules and other data for the computer system 100. In FIG. 1, for example, hard disk drive 122 is illustrated as storing operating system 112, application programs 114, other executable code 116 and program data 118. A user may enter commands and information into the computer system 100 through an input device 140 such as a keyboard and pointing device, commonly referred to as mouse, trackball or touch pad tablet, electronic digitizer, or a microphone. Other input devices may include a joystick, game pad, satellite dish, scanner, and so forth. These and other input devices are often connected to CPU 102 through an input interface 130 that is coupled to the system bus, but may be connected by other interface and bus structures, such as a parallel port, game port or a universal serial bus (USB). A display 138 or other type of video device may also be connected to the system bus 120 via an interface, such as a video interface 128. In addition, an output device 142, such as speakers or a printer, may be connected to the system bus 120 through an output interface 132 or the like computers.

The computer system 100 may operate in a networked environment using a network 136 to one or more remote computers, such as a remote computer 146. The remote computer 146 may be a personal computer, a server, a router, a network PC, a peer device or other common network node, and typically includes many or all of the elements described above relative to the computer system 100. The network 136 depicted in FIG. 1 may include a local area network (LAN), a wide area network (WAN), or other type of network. Such networking environments are commonplace in offices, enterprise-wide computer networks, intranets and the Internet. In a networked environment, executable code and application programs may be stored in the remote computer. By way of example, and not limitation, FIG. 1 illustrates remote executable code 148 as residing on remote computer 146. It will be appreciated that the network connections shown are exemplary and other means of establishing a communications link between the computers may be used.

### Scheduling Online Keyword Auctions Over Multiple Time Periods Subject to Budget and Query Volume Constraints

The present invention is generally directed towards a system and method for scheduling online keyword auctions for multiple time periods over a time span subject to budget and query volume constraints. A linear programming model of slates of advertisements may be created offline for predicting the frequency and sequence of keywords occurring for multiple time periods throughout a time span for use in online scheduling of bidders to auctions that may optimize revenue of an auctioneer. Each slate of advertisements may represent a candidate set of advertisements in order of optimal revenue to an auctioneer. Linear programming using column generation with the keyword as a constraint, a bidder's budget as a constraint, query volume as a constraint and a time period as a constraint may be applied to generate columns that may be added to the linear programming model of slates of advertisements in order to determine optimal revenue to an auctioneer. Upon receiving a query request, a slate of advertisements may be chosen online according to the generated frequencies, and the chosen slate of advertisements may then be output for sending to a web browser for display.

As will be seen, the linear programming model of slates of advertisements may be periodically adjusted over the time span for multiple time periods in various embodiments. As will be understood, the various block diagrams, flow charts and scenarios described herein are only examples, and there are many other scenarios to which the present invention will apply.

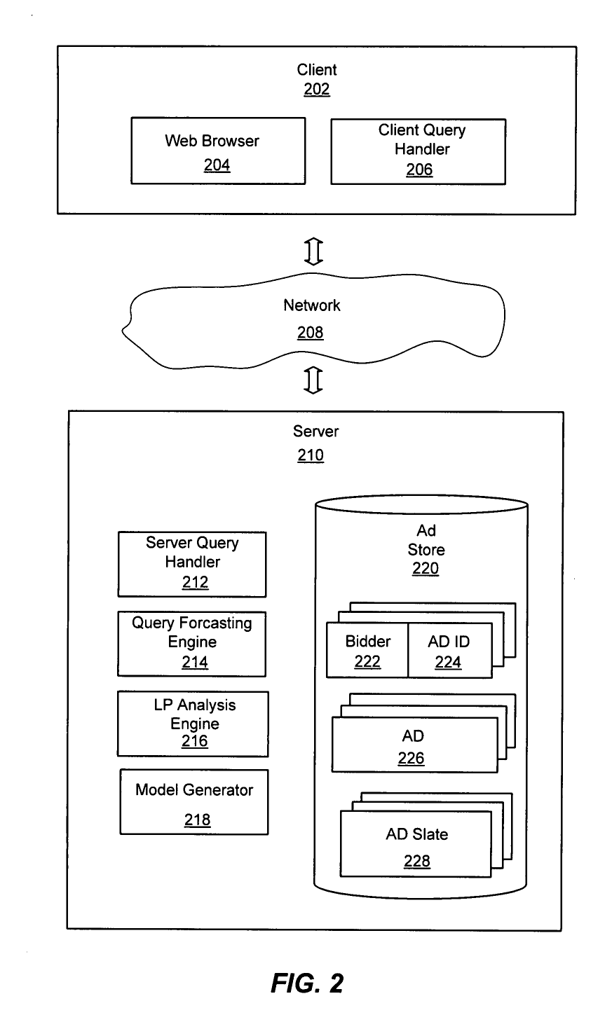

Turning to FIG. 2 of the drawings, there is shown a block diagram generally representing an exemplary architecture of system components for scheduling online keyword auctions for multiple time periods over a time span subject to budget and query volume constraints. Those skilled in the art will appreciate that the functionality implemented within the blocks illustrated in the diagram may be implemented as separate components or the functionality of several or all of the blocks may be implemented within a single component. For example, the functionality for the client query handler 206 may be included in the same component as the web browser 204. Or the functionality of the model generator 218 may be implemented as a separate component on another server. Moreover, those skilled in the art will appreciate that the functionality implemented within the blocks illustrated in the diagram may be executed on a single computer or distributed across a plurality of computers for execution.

In various embodiments, a client computer 202 may be operably coupled to one or more servers 210 by a network 208. The client computer 202 may be a computer such as computer system 100 of FIG. 1. The network 208 may be any type of network such as a local area network (LAN), a wide area network (WAN), or other type of network. A web browser 204 may execute on the client computer 202 and may include functionality for receiving a search request which may be input by a user entering a query. The web browser 204 may be operably coupled to a client query handler 206 that may include functionality for receiving a query entered by a user and for sending a query request to a server to obtain a list of search results. In general, the web browser 204 and the client query handler 206 may be any type of interpreted or executable software code such as a kernel component, an application program, a script, a linked library, an object with methods, and so forth.

The server 210 may be any type of computer system or computing device such as computer system 100 of FIG. 1. In general, the server 210 may provide services for query processing and may include services for providing a list of auctioned advertisements to accompany the search results of query processing. In particular, the server 210 may include a server query handler 212 for receiving and responding to query requests, a query forecasting engine 214 for predicting the query volume during multiple time periods of a time span, a model generator 218 for creating a linear programming model used to provide a candidate set of advertisements for keywords of query requests for multiple time periods, and a linear program analysis engine, or optimizer, 216 for choosing slates of advertisements for keywords of the queries expected for processing for multiple time periods. Each of these modules may also be any type of executable software code such as a kernel component, an application program, a linked library, an object with methods, or other type of executable software code.

The server 210 may be operably coupled to a database of advertisements such as ad store 220 that may include any type of advertisements 226 that may be associated with an ad ID 224. In an embodiment, several bidders 222 may be associated with an ad ID 224 for one or more advertisements 226. The ad store 220 may also include a collection of ad slates 228 that may be generated as part of the linear programming model, each ad slate representing an ordered candidate set of advertisements for keywords of a query request.

There are many applications which may use the present invention for scheduling online keyword auctions for multiple time periods over a time span subject to budget and query volume constraints. For example, online search advertising applications may use the present invention to schedule keyword auctions subject to bidders' budget constraints. Or online search advertising applications may use the present invention to schedule keyword auctions by expected revenue rather than by bid. For any of these applications, advertisement auctions may be scheduled that optimize the objective of the auctioneer.

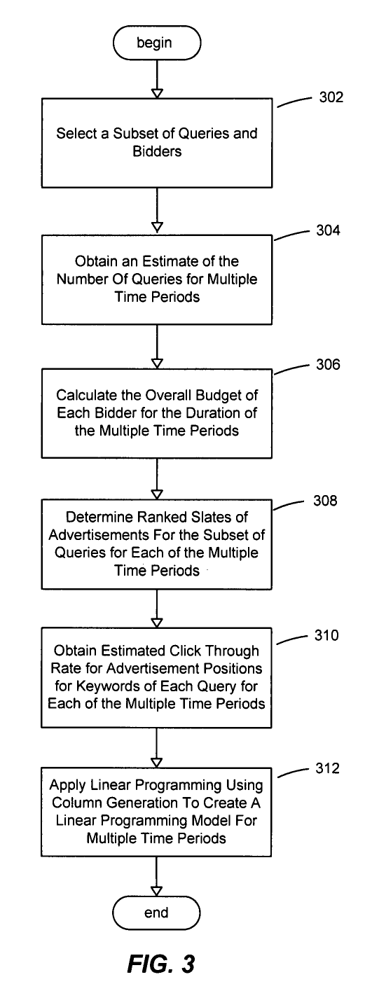

FIG. 3 presents a flowchart for generally representing the steps undertaken in one embodiment for scheduling online keyword auctions for multiple time periods over a time span subject to budget and query volume constraints by applying linear programming using column generation. In an embodiment, consider M={Θ, B} to be an auction marketplace, where Θ={q₁, q₂, . . . , q_{N}} may be a set of possible queries and B={b₁, b₂, . . . , b_{M}} may be a set of all bidders. Also consider the “bidding state” of the auction marketplace to be defined for multiple time periods, t={1, . . . , T}, by a matrix A^{t}, where A^{t}_{i,j} may be the bid amount that the j-th bidder may be bidding on the i-th query qᵢ for time period t. Assuming a static bidding state (A^{t}=A), consider the daily budget limit that may be specified by each bidder bⱼ to be defined as dⱼ. Note that in an embodiment, dⱼ can represent the daily budget for a campaign, where a buyer may be associated with multiple campaigns. Thus dⱼ may represent a daily spend limit by a bidder (or campaign) across multiple queries. If a daily budget limit may not be specified for a bidder, then assume that dⱼ=∞.

For each query qᵢ, consider R_{i,j}^{t}=A_{i,j}^{t}·Q_{i,j}^{t} to be the ranking function used to rank the j-th offer in an auction instance, where Q_{i,j}^{t} may be a time-dependent weighting factor, or “quality score” for the i-th query and j-th bidder for time period t. The ranking function R_{i,j}^{t} may be equal to zero for any bidder bⱼ that may not participate in an auction instance. A linear programming model may be created for this defined marketplace as further described below.

At step 302, a set of queries bid upon by a set of bidders may be selected from the expected query set. For example, queries received for a previously occurring day may be selected and a set of bidders who have bid on those queries may be selected. At step 304, an estimate of the number of queries may be obtained for multiple time periods over a time span. In an embodiment, there may be twenty-four hour-long time periods defined for a 24 hour day. In various other embodiments, the time periods may be fifteen minutes long, thirty minutes long, a period of a day and so forth.

Once an estimate of the number of queries may be obtained for multiple time periods over a time span, an overall budget for each bidder may be calculated for the time span of the multiple time periods at step 306. At step 308, ranked slates of advertisements may be determined for the subset of queries for each of the multiple time periods. For each query qᵢ in time period t, the “bidding landscape” may be defined in an embodiment as a set of bidder indices Lᵢ^{t}={jₚ:R_{i,j}_{ₚ}^{t}>0,p=1, . . . , Pᵢ}, where the indices jₚ may be sorted by the value of R_{i,j}^{t} in descending order, and Pᵢ may be the number of bidders in the landscape.

Furthermore, a slate of advertisements may be defined for a time period t that may be a subset of the bidding landscape Lᵢ^{t}. Each bidding landscape Lᵢ^{t} for a time period t may be mapped into a set of slates Lᵢ^{kt}, each being a unique subset of Lᵢ^{t} which can be obtained by deleting members of Lᵢ^{t} while maintaining the ordering and then truncating, if necessary, to Pᵢ^{k} members. More formally, the k^{th} slate for advertisement i for time period t, may include a unique subset (of length Pᵢ^{k}) of the indices of Lᵢ^{t}, and may be defined as Lᵢ^{kt}={jₖ_{ₗ}:jₖ_{ₗ} εLᵢ^{t},l≦Pᵢ^{k}≦P}, where P may be the maximum number of slots available for advertising on a page, such as a web browser. The indices in Lᵢ^{kt} may be ordered as in Lᵢ^{t}, such as in order of ranking R_{i,j}^{t}. In an embodiment, if there may be less than P+1 members, an additional dummy member may be added to Lᵢ^{kt} for the purpose of computing second-bid prices.

At step 310, the estimated click-through-rate may be determined for advertisement positions for keywords of each query for each of the multiple time periods. For a query qᵢ in time period t, consider T_{i,j}^{t}(p) to denote the expected click-through-rate (“CTR”) for a bidder j who may be ranked at slot p on a page.

In general, the data collected in steps 302 through 310 may be stored for use by the linear programming analysis engine to apply linear programming using column generation to determine the relative frequency for each slate to provide optimal revenue. At step 312, linear programming using column generation may be applied to determine the relative frequency for each slate to provide optimal revenue for each of the multiple time periods.

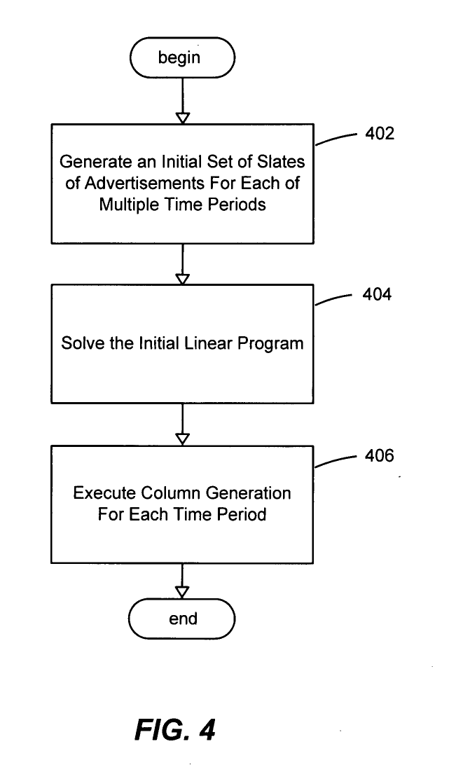

FIG. 4 presents a flowchart for generally representing the steps undertaken in one embodiment for applying linear programming using column generation to determine a relative frequency for each slate to provide optimal revenue for each of the multiple time periods over a time span. In general, the data collected from steps 302 through 310 for the linear programming model may be read from storage by the linear programming module in order to formulate and build the model as follows. Consider xᵢₖ^{t} to represent the number of times to show slate k for keyword i in time period t. In general, values for xᵢₖ^{t}≧0 may be found, such that revenue for a time period may be maximized and spending may be less than the budget for all bidders j.

The expected revenue-per-search (rps) may be defined in a 2^{nd} bid pricing model for a slate and a query in a time period as:

$$rps ( {L}_{i}^{kt} ) = {\sum }_{l = 1}^{{P}_{i}^{k}} {T}_{i , {j}_{{k}_{l}}}^{t} ( l ) \cdot {A}_{i , {j}_{{k}_{l} + 1}}^{t} \frac{{Q}_{i , {j}_{{k}_{l} + 1}}^{t}}{{Q}_{i , {j}_{{k}_{l}}}^{t}}$$

The total revenue over all queries for the time span of multiple time periods may therefore be defined as:

$$Rev = {\sum }_{t} {\sum }_{k} {\sum }_{i = 1}^{N} rps ( {L}_{i}^{kt} ) {x}_{ik}^{t} .$$

The daily spend for each bidder j may be represented as

$${Spend}_{j} = {\sum }_{t} {\sum }_{k} {\sum }_{i = 1}^{N} {δ}_{j} ( i , k , t ) {x}_{ik}^{t} , where {δ}_{j} ( i , k , t ) = {T}_{i , {j}_{{k}_{p}}}^{t} ( p ) \cdot {U}_{i , {j}_{{k}_{p}}}^{t} , \\ and {U}_{i , {j}_{{k}_{p}}}^{t}$$

may be the price bidder j pays every time his advertisement may be clicked at position p for the k-th slate of qᵢ in time period t, defined as:

$${U}_{i , {j}_{{k}_{p}}}^{t} = \{ \begin{matrix}{A}_{i , {j}_{{k}_{p + 1}}}^{t} \cdot \frac{{Q}_{i , {j}_{{k}_{p + 1}}}^{t}}{{Q}_{i , {j}_{{k}_{p}}}^{t}} & 0 < p < {P}_{i}^{k} \leq P \\ 0 & otherwise .\end{matrix}$$

Linear programming with column generation may be used to find the optimal allocation. For example, consider dⱼ to be the budget for bidder j; consider vᵢ^{t} to be the expected number of occurrences of the i-th keyword in time period t; consider cᵢⱼₖ^{t}=δⱼ(i,k,t) to be the expected cost to bidder j if slate k may be shown for keyword i in time period t; and rᵢⱼₖ^{t}=rps(Lᵢ^{kt}) to be the expected revenue on slate k for keyword i in time period t. For a budget defined as

$${\sum }_{t} {\sum }_{i} {\sum }_{k} {c}_{ijk}^{t} {x}_{ik}^{t} \leq {d}_{j} ∀ j = 1 , … , M ,$$

and an inventory defined as

$${\sum }_{k} {x}_{ik}^{t} \leq {v}_{i}^{t}$$

∀ i=1, . . . , N; the relative frequency for each slate to provide optimal revenue may be determined by maximizing

$${\sum }_{t} {\sum }_{i} {\sum }_{k} {r}_{ik}^{t} {x}_{ik}^{t} .$$

Using a conventional column-generation approach (See “A Column Generation Approach for Combinatorial Auctions”, Workshop on Mathematics of the Internet: E-Auction and Markets Institute for Mathematics and its Applications (2001) by Brenda Dietrich and John J. Forrest), an initial subset of slates for each of the multiple time periods, Lᵢ^{t}εLᵢ^{kt}, may be generated at step 402 and the corresponding linear program may be solved at step 404,and then columns may be generated as needed using dual values of a linear program at step 406 for each time period. For instance, consider πⱼ to be the marginal value for bidder j's budget, more specifically, the simplex multipliers for the j^{th} constraint of

$${\sum }_{t} {\sum }_{i} {\sum }_{k} {c}_{ijk}^{t} {x}_{ik}^{t} \leq {d}_{j} ∀ j = 1 , … , M ,$$

and consider γᵢ to be the marginal value for the i^{th} keyword, more specifically, the simplex multipliers for the i^{th} constraint of

$${\sum }_{k} {x}_{ik}^{t} \leq {v}_{i}^{t} ∀ i = 1 , … , N ,$$

then a column corresponding to slate Lᵢ^{kt} at time period t (and hence to variable xᵢₖ^{t}) may be profitably introduced into the linear programming model if

$${r}_{ik}^{t} - {\sum }_{j ∈ {L}_{i}^{kt}} {c}_{ijk}^{t} {π}_{j} - {γ}_{i} > 0.$$

Accordingly, for each keyword i at time period t,

$${r}_{ik}^{i} - {\sum }_{j ∈ {L}_{i}^{kt}} {c}_{ijk}^{t} {π}_{j}$$

may be maximized over the legal slates Lᵢ^{kt}. If a slate may be found such that

$${r}_{ik}^{t} - {\sum }_{j ∈ {L}_{i}^{kt}} {c}_{ijk}^{t} {π}_{j} - {γ}_{i} > 0 ,$$

the corresponding slate and its variable may be introduced into the linear programming model. If no such slate exists for any i, then an optimal solution may have been obtained. Those skilled in the art will appreciate that in an alternate embodiment,

$${\sum }_{j ∈ {L}_{i}^{kt}} {c}_{ijk}^{t} {π}_{j} - {r}_{ij}^{t}$$

may be equivalently minimized over the legal slates Lᵢ^{kt}.

Rather than generate every slate Lᵢ^{kt} a priori, after an initial subset of slates, Lᵢ^{t}εLᵢ^{kt}, may be generated, then columns may be generated as needed using the dual values πⱼ and γᵢ of a linear program. For instance, considering the coefficients

$${r}_{ik}^{t} = rps ( {L}_{i}^{kt} ) = {\sum }_{l = 1}^{{P}_{i}^{k}} {T}_{i , {j}_{{k}_{l}}}^{t} ( l ) \cdot {A}_{i , {j}_{{k}_{l} + 1}}^{t} \frac{{Q}_{i , {j}_{{k}_{l} + 1}}^{t}}{{Q}_{i , {j}_{{k}_{l}}}^{t}} and$$

$${c}_{i , {j}_{{k}_{p}}}^{t} = {T}_{i , {j}_{{k}_{p}}}^{t} ( p ) \cdot {A}_{i , {j}_{{k}_{p + 1}}}^{t} \cdot \frac{{Q}_{i , {j}_{{k}_{p + 1}}}^{t}}{{Q}_{i , {j}_{{k}_{p}}}^{t}} in {r}_{ik}^{t} - {\sum }_{j ∈ {L}_{i}^{kt}} {c}_{ijk}^{t} {π}_{j} - {γ}_{i} > 0 , \\ {F}_{ik}^{t} ( π ) = {\sum }_{l = 1}^{{P}_{i}^{k}} {T}_{i , {j}_{{k}_{l}}}^{t} ( l ) \cdot {A}_{i , {j}_{{k}_{l} + 1}}^{t} \cdot \frac{{Q}_{i , {j}_{{k}_{l} + 1}}^{t}}{{Q}_{i , {j}_{{k}_{l}}}^{t}} \cdot ( 1 - {π}_{{j}_{{k}_{l}}} )$$

may be maximized for a given πⱼ over slates Lᵢ^{kt} in time period t.

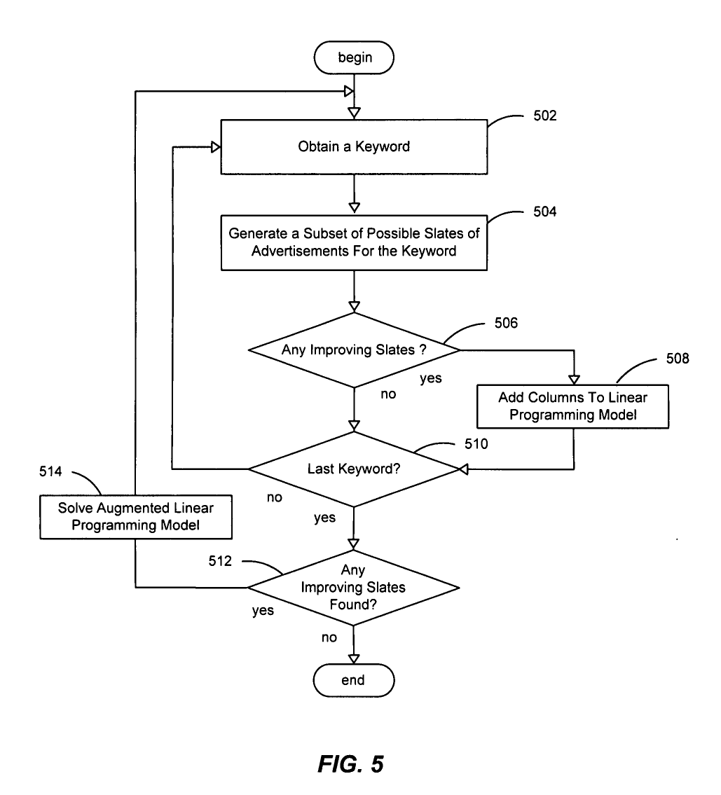

FIG. 5 presents a flowchart for generally representing the steps undertaken in one embodiment for determining one or more slates of advertisements that may improve the objective by generating one or more columns of the linear programming model for a time period. A keyword may be obtained at step 502, for instance, from a query. At step 504, a subset of Lᵢ^{t} may be generated for a keyword i of a query for the time period t, and it may be determined at step 506 whether the subset may provide an improved solution. In an embodiment, the subset of Lᵢ^{t} may provide an improved solution if upon evaluating

$${F}_{ik}^{t} ( π ) = {\sum }_{l = 1}^{{P}_{i}^{k}} {T}_{i , {j}_{{k}_{l}}}^{t} ( l ) \cdot {A}_{i , {j}_{{k}_{l} + 1}}^{t} \cdot \frac{{Q}_{i , {j}_{{k}_{l} + 1}}^{t}}{{Q}_{i , {j}_{{k}_{l}}}^{t}} \cdot ( 1 - {π}_{{j}_{{k}_{l}}} ) , {F}_{ik}^{t} ( π ) > {γ}_{i} .$$

If so, the column(s) corresponding to the subset of Lᵢ^{kt} may be added to the linear programming model at step 508. If the condition of Fᵢₖ^{t}(π)>γᵢ may not be satisfied, then it may be determined at step 510 whether the keyword may be the last keyword included in the query. If not, then processing may continue at step 502.

If all keywords have been processed, then it may be determined at step 512 whether any improving slate may have been found, that is some Lᵢ^{kt} may be found for which Fᵢₖ^{t}(π)>γᵢ. If so, the augmented linear program incorporating the additional columns generated at step 508 may be solved, and processing may continue to step 502. If it may be determined at step 512 that no improving slate may be found, then processing may be finished since there may not be found any new column satisfying the condition of Fᵢₖ^{t}(π)>γᵢ, and the linear programming model may provide an optimal solution.

Thus, the present invention may reduce the columns of the linear programming model to a manageable size by using a subset of possible combinations of advertisements which can be shown for each keyword. Once created, advertisement slates and frequencies may also be available for caching. In other embodiments, the linear programming analysis engine may associate with each slate of advertisements an indicator of priority or value, and an expected traffic volume. In such embodiments, the query processing server may choose a slate of advertisements online in accordance with the expected traffic priorities and values prescribed. Moreover, the framework described may also apply when the budget constraints for one or more bidders may require those bidders to be removed from a set of bidders. In this case, subsequent bidders may be moved up the order in a slate of advertisements.

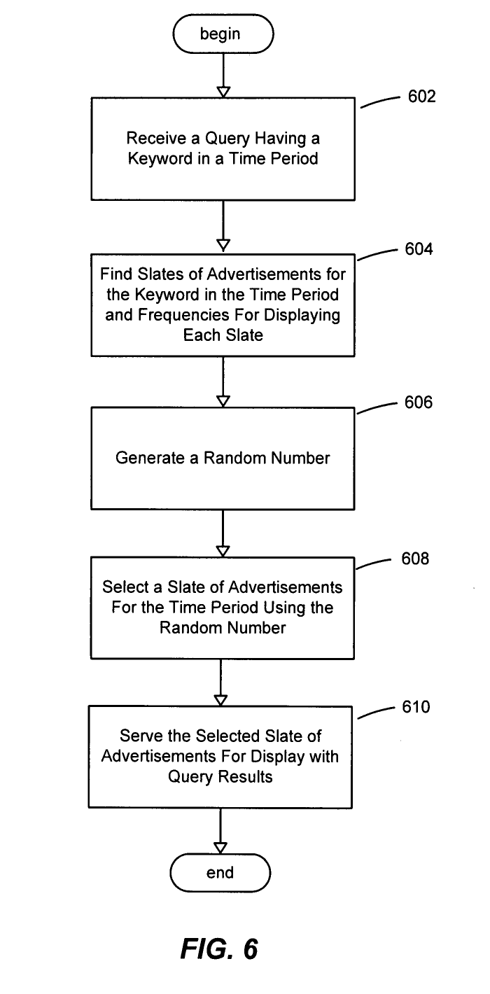

FIG. 6 presents a flowchart for generally representing the steps undertaken in one embodiment for responding to queries applying the results of a linear programming model of advertising auctions subject to budget constraints. Note that FIG. 6 may present a flow chart for one embodiment of the process of serving the slates of ads generated by the linear programming model. The slates of advertisements generated by the linear programming model may be stored as in 226 for use by the ad server. A query having a keyword may be received at step 602, and slates of advertisements for the keyword may be found at step 604 along with their associated frequencies. A random, or pseudo-random number, may be generated at step 606 with the same distibution as the specified frequencies. And the generated random number may be used at step 608 to select a slate of advertisements to show with the query results. The selected slate of advertisements may be served at step 610 for display with the query results.

In addition to a client-server application that may implement the steps described in conjunction with FIG. 6 for serving a slate of advertisements, the present invention may also be applied for optimizing throttling rates used in applications to remove advertisements of bidders from a slate of advertisements when the bidders have spent an expected amount of their budget. Advantageously, applying the present invention for optimizing throttling rates may provide an advertising allocation that may requires less online computing resources by a server than direct application of the linear programming model of the present invention. For example, in an embodiment of a direct application of the linear programming model of the present invention, a server may be configured to maintain access to a database of all the slates of advertisements generated in an optimal solution, as well as their frequencies for display. In various applications that may use throttling of bidders, the optimal slates of advertisements along with the frequency data may be post-processed to obtain “throttling rates” which may then be applied to the holding out of a bidder from the bidder landscape, either on a query independent basis or on a query-bidder pair basis.

Despite the best predictive tools, the system parameters may, however, change in unpredictable ways, and even if forecasting was 100% accurate, randomly choosing a slate may create some amount of variation. To accommodate for unpredictable variation, the linear programming solution may be resolved throughout the course of a time span in another embodiment, and the slate frequencies may be updated accordingly. Such an update may be applied at time points when there have been significant inaccuracies in the forecast, or, at periodic time intervals, for example every hour. Although this re-computation requires more computational resources, it allows the slate frequencies to adjust to changes in the environment as the day progresses. In simulations, resolving the linear program for periodic time intervals of one hour may lead to a 5% increase in revenue gains over computing slate frequencies once for a time span of a day.

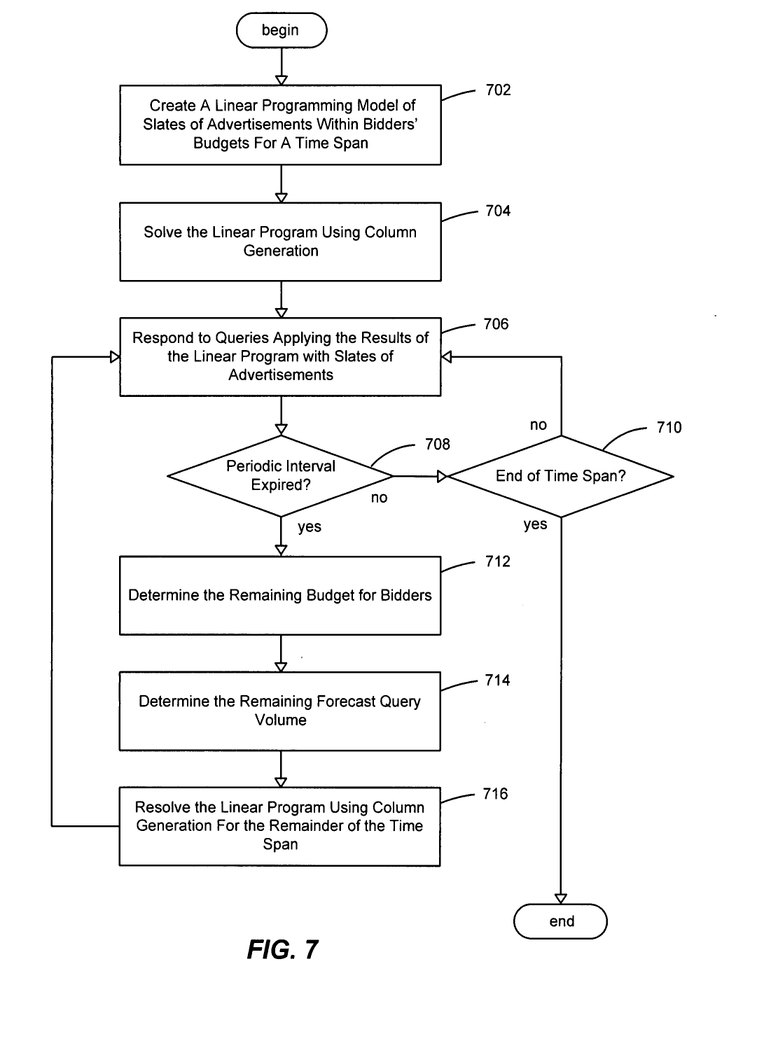

FIG. 7 presents a flowchart for generally representing the steps undertaken in one embodiment for scheduling online advertising auctions subject to budget constraints by periodically adjusting parameters of a linear program using column generation. Using the method described in related copending U.S. patent application Ser. No. 11/497,085, entitled “SYSTEM AND METHOD FOR SCHEDULING ONLINE KEYWORD AUCTIONS SUBJECT TO BUDGET CONSTRAINTS,” assigned to the assignee of the present invention, a model of slates of advertisements within bidders' budgets may be created at step 702 for a time span, the linear program may be solved at step 704, and the results of the linear program may be applied at step 706 to respond to queries with slates of advertisements.

It may then be determined at step 708 whether a periodic time interval has expired. In an embodiment, a timer may be set to expire after a fixed interval of time, such as an hour. If the periodic time interval has not expired, then it may be determined at step 710 whether the time span has ended. If the time span has ended, then processing may be finished for scheduling online advertising auctions subject to budget constraints by periodically adjusting parameters of a linear program using column generation. Otherwise, processing may continue at step 706.

If it may be determined at step 708 that the periodic time interval has expired, then the remaining budget for bidders may be determined at step 712. For example, the remaining budget for bidder j in time period t may be determined using the following equation: dⱼ^{rem}(t)=dⱼ−dⱼ^{done}(t), where dⱼ^{rem}(t) is the budget remaining at time period t and dⱼ^{done}(t) is the amount of budget that has already been spent at time period t. The remaining forecast query volume may then be determined at step 714. For instance, the remaining forecast query volume for query i in time period t may be determined using the following equation: vᵢ^{rem}(t)=vᵢ−vᵢ^{done}(t), where vᵢ^{rem}(t) is the query volume remaining at time period t for query i and vᵢ^{done} (t) is the amount of query volume completed at time period t. In various other embodiments, the query volume remaining for query i may be estimated for each remaining periodic time period and vᵢ^{rem}(t) may be set to be the sum of the estimated volume of query i for each remaining periodic time period of the time span.

And the linear program may be resolved using column generation for the remainder of the time span at step 716 and processing may continue at step 706 where the results of the linear program may be applied to respond to queries with slates of advertisements. In an embodiment, slate frequencies may be obtained for a given time period by solving a modified linear program, where the budget constraints may be represented by the equation

$${\sum }_{i} {\sum }_{k} {c}_{ijk} {x}_{ik} \leq {d}_{j}^{r em} ( t ) ∀ j ,$$

the query volume constraints may be represented by the equation

$${\sum }_{k} {x}_{ik} \leq {v}_{i}^{re m} ( t ) ∀ i ,$$

and the revenue objective may be represented by the equation

$$Maximize {\sum }_{i} {\sum }_{k} {r}_{ik} {x}_{ik} .$$

In another embodiment, the full linear program using column generation may be solved for a time span to derive the portion of a bidder's budget for spending on each query, and then a linear program may be generated for each query at periodic time intervals to determine slates for use for that particular query, rather than periodically adjusting parameters of the linear program and resolving the full linear program using column generation at periodic time intervals.

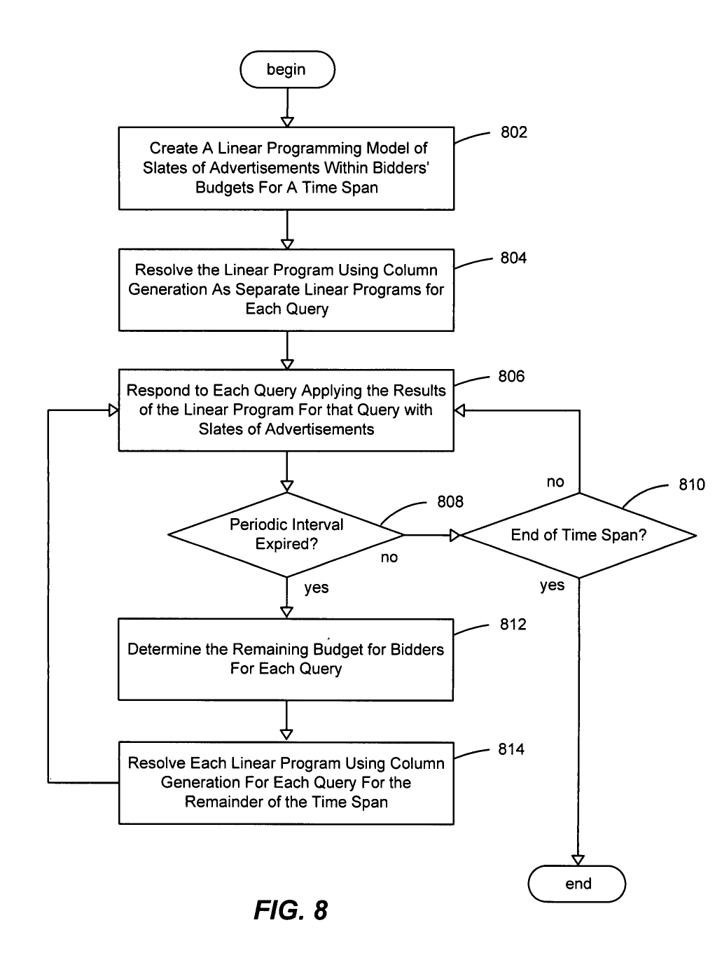

FIG. 8 presents a flowchart for generally representing the steps undertaken in one embodiment for scheduling online advertising auctions subject to budget constraints by periodically adjusting parameters of many linear programs using column generation, one for each query, to determine slates for use for each particular query. Using the method described in related co-pending U.S. patent application Ser. No. 11/497,085, entitled “SYSTEM AND METHOD FOR SCHEDULING ONLINE KEYWORD AUCTIONS SUBJECT TO BUDGET CONSTRAINTS,” assigned to the assignee of the present invention, a model of slates of advertisements within bidders' budgets may be created at step 802 for a time span. The linear program using column generation may be resolved at step 804 as many separate linear programs, one for each query. In an embodiment, an equivalent linear program may be reformulated by introducing new variables for Dᵢⱼ=Σ_{k:jεL}_{ᵢ}_{^{k}}cᵢⱼₖxᵢₖ, representing the portioned budget of bidder j for query i. It may be only necessary to assign these variables for jεLᵢ. The constraints from the linear program in step 802 can be equivalently written as:

$${\sum }_{k \text{:} j ∈ {L}_{i}^{k}} {c}_{ijk} {x}_{ik} \leq {D}_{ij} ∀ i , j$$

for the query-level budget constraints,

$${\sum }_{i} {D}_{ij} \leq {d}_{j} ∀ j$$

for the high-level budget constraints, and

$${\sum }_{k} {x}_{ik} \leq {v}_{i} ∀ i$$

for the query volume constraints. Consider that values may be known for the Dᵢⱼ's that satisfy this revised linear program. Then the high-level budget constraints,

$${\sum }_{i} {D}_{ij} \leq {d}_{j} ∀ j ,$$

can be eliminated, and the linear program may be rewritten as a large number of separate linear programs, one for each query. Given values for the Dᵢⱼ's, each linear program for a single query i may be solved using the following constraints:

$${\sum }_{k \text{:} j ∈ {L}_{i}^{k}} {c}_{ijk} {x}_{ik} \leq {D}_{ij} ∀ i , j$$

for the query-level budget constraints,

$${\sum }_{k} {x}_{ik} \leq {v}_{i} ∀ i$$

for the query volume constraints, and

$$Maximize {\sum }_{i} {\sum }_{k} {r}_{ik} {x}_{ik}$$

as the revenue objective. And the results of each linear program may be applied at step 806 to respond to its corresponding query with slates of advertisements.

It may then be determined at step 808 whether a periodic time interval has expired. In an embodiment, a timer may be set to expire after a fixed interval of time, such as an hour. If the periodic time interval has not expired, then it may be determined at step 810 whether the time span has ended. If the time span has ended, then processing may be finished for scheduling online advertising auctions subject to budget constraints by periodically adjusting parameters of many linear programs using column generation. Otherwise, processing may continue at step 806.

If it may be determined at step 808 that the periodic time interval has expired, then the remaining budget for bidders may be determined at step 812 for each query. For example, the remaining budget for bidder j for query i in time period t may be determined using the following equation: Dᵢⱼ^{rem}(t)=Dᵢⱼ−Dᵢⱼ^{done}(t), where Dᵢⱼ^{rem}(t) is the budget remaining for bidder j for query i at time period t and Dᵢⱼ^{done}(t) is the amount of budget that has already been spent by bidder j for query i at time period t.

And each linear program may be resolved using column generation for each query for the remainder of the time span at step 814 and processing may continue at step 806 where the results of each linear program may be applied to respond to its corresponding query with slates of advertisements. In an embodiment, slate frequencies may be obtained for a given time period by solving each modified linear program for a single query i where the query-level budget constraints may be represented by the equation

$${\sum }_{k \text{:} j ∈ {L}_{i}^{k}} {c}_{ijk} {x}_{ik} \leq {D}_{ij}^{re m} ( t ) ∀ i , j ,$$

the query volume constraints may be represented by the equation

$${\sum }_{k} {x}_{ik} \leq {v}_{i} ∀ i ,$$

and the revenue objective may be represented by the equation

$$Maximize {\sum }_{i} {\sum }_{k} {r}_{ik} {x}_{ik} .$$

The solution of generating a linear program for each query at periodic time intervals to determine slates for use for that particular query may be relatively simple, fast, and easy to implement compared to the implementation of an embodiment for periodically adjusting parameters of the linear program and resolving a modified linear program using column generation at periodic time intervals. By generating a linear program for each query at periodic time intervals to determine slates for use for that particular query, the benefits of periodic adjustment may advantageously be achieved without high computational demands. As bidders come, go and change their values, this implementation may isolate the impact of their changes.

As can be seen from the foregoing detailed description, the present invention provides an improved system and method for scheduling online keyword auctions over multiple time periods subject to budget constraints. Such a system and method may efficiently schedule bidders to auctions to optimize revenue of an auctioneer. The system and method may also apply broadly to online search advertising applications and may be used, for example, to schedule keyword auctions by expected revenue rather than by bid. As a result, the system and method provide significant advantages and benefits needed in contemporary computing and in online applications.

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

What is claimed is:

1. A computer-implemented method for scheduling online auctions, comprising:
receiving a query having a keyword in a time period;
finding slates of advertisements for the keyword for the time period and frequencies for displaying each slate of advertisements, each slate representing a candidate set of advertisements generated by a linear programming model of slates of advertisements for each of a plurality of time periods;
selecting a slate of advertisements for display with results of the query; and
outputting the slate of advertisements for display with the results of the query.

2. The method of claim 1 further comprising creating the linear programming model of slates of advertisements for each of the plurality of time periods.

3. The method of claim 2 wherein creating the linear programming model of slates of advertisements for each of the plurality of time periods comprises selecting a subset of queries and bidders.

4. The method of claim 2 wherein creating the linear programming model of slates of advertisements for each of the plurality of time periods comprises obtaining an estimate of the number of queries for each of the plurality of time periods.

5. The method of claim 2 wherein creating the linear programming model of slates of advertisements for each of the plurality of time periods comprises calculating an overall budget for each bidder for the time span of the plurality of time periods.

6. The method of claim 2 wherein creating the linear programming model of slates of advertisements for each of the plurality of time periods comprises determining ranked slates of advertisements for the subset of queries for each of the plurality of time periods.

7. The method of claim 2 wherein creating the linear programming model of slates of advertisements for each of the plurality of time periods comprises estimating click through rates for advertisement positions in a slate of advertisements for the keyword of the query for each of the plurality of time periods.

8. The method of claim 6 wherein determining ranked slates of advertisements for the subset of queries for each of the plurality of time periods comprises determining a set of bidder indices that may be ranked in descending order using a ranking function with a weighting factor for the subset of queries and a set of bidders for each of the plurality of time periods.

9. The method of claim 6 wherein determining ranked slates of advertisements for the subset of queries for each of the plurality of time periods comprises determining a number of slots available for advertising on a display page.

10. The method of claim 2 wherein creating the linear programming model of slates of advertisements for each of the plurality of time periods comprises applying linear programming using the keyword counts as a constraint and bidders' budgets as a constraint for each of the plurality of time periods to generate columns that may be added to a linear programming model.

11. The method of claim 10 wherein applying linear programming using the keyword counts as a constraint and the bidders' budgets as a constraint for each of the plurality of time periods to generate the columns that may be added to the linear programming model of slates of advertisements comprises determining the expected cost to a bidder for showing a slate of advertisements for the keyword for each of the plurality of time periods.

12. The method of claim 10 wherein applying linear programming using the keyword counts as constraints and the bidders' budgets as a constraint for each of the plurality of time periods to generate the column that may be added to the linear programming model of slates of advertisements comprises determining an expected revenue to an auctioneer for showing a slate of advertisements for the keyword in each of the plurality of time periods.

13. The method of claim 1 wherein outputting the slate of advertisements for display with the results of the query comprises including the slate of advertisements in a web page for display to a user.

14. A computer-readable medium having computer-executable instructions for performing the method of claim 1.

15. A computer-implemented method for scheduling online auctions, comprising:
creating a linear program of slates of advertisements for a time span using a plurality of keyword counts as a first constraint and a plurality of budgets for a plurality of bidders as a second constraint;
solving the linear program using column generation as a plurality of linear programs using column generation, each of the plurality of linear programs generated for each of a plurality of queries;
receiving a query of the plurality of queries having a keyword;
finding slates of advertisements for the keyword and frequencies for displaying each slate of advertisements, each slate representing a candidate set of advertisements generated by a linear program of the plurality of linear programs for the query;
selecting a slate of advertisements for display with results of the query; and
outputting the slate of advertisements for display with the results of the query.

16. The method of claim 15 further comprising:
determining a remaining budget for the plurality of bidders for each of the plurality of queries;
resolving each of the plurality of linear programs using column generation for each of the plurality of queries for a remainder of the time span;
receiving a second query of the plurality of queries having a second keyword;
finding slates of advertisements for the second keyword and frequencies for displaying each slate of advertisements, each slate representing a candidate set of advertisements generated by a resolved linear program of the plurality of resolved linear programs for the second query;
selecting a slate of advertisements for display with results of the second query; and
outputting the slate of advertisements for display with the results of the second query.

17. A computer-readable medium having computer-executable instructions for performing the method of claim 15.

18. A computer system for scheduling online auctions, comprising:
means for creating at least one linear program of slates of advertisements for a time span using a plurality of keyword counts as a first constraint and a plurality budgets for a plurality of bidders as a second constraint;
means for solving the at least one linear program using column generation;
means for responding to a plurality of queries applying the results of the at least one linear program with slates of advertisements; and
means for periodically adjusting at least one linear program using column generation during the time span.

19. The computer system of claim 18 wherein means for periodically adjusting at least one linear program using column generation during the time span comprises:
means for determining a remaining budget for the plurality of bidders for each of the plurality of queries; and
means for resolving each of a plurality of linear programs using column generation for each of the plurality of queries for a remainder of the time span.

20. The computer system of claim 18 wherein means for periodically adjusting at least one linear program using column generation during the time span comprises:
means for determining a remaining budget for the plurality of bidders for each of the plurality of queries;
means for determining a remaining forecast volume for each of the plurality of queries; and
means for resolving the at least one linear program using column generation for a remainder of the time span.
